(19) United States
(12) Patent Application Publication
(10) Pub. No.: US 2010/0176742 A1
(43) Pub. Date: Jul. 15, 2010

(54) Illumination Apparatus and Driving Method Thereof

(76) Inventors: Young Hwan LEE, Seoul (KR); Kwan Soo Jang, Seoul (KR); Chung Hyun Cho, Goyang-si (KR)

Correspondence Address: THE LAW OFFICES OF ANDREW D. FORTNEY, PH.D., P.C., 215 W FALLBROOK AVE SUITE 203, FRESNO, CA, 93711, US

(21) Appl. No.: 12/684,360

(22) Filed: Jan. 8, 2010

(30) Foreign Application Priority Data
Jan. 9, 2009 (KR) 10-2009-0001709

(51) Int. Cl. H05B 37/02

(52) U.S. Cl. 315/294

(57) ABSTRACT

An illumination apparatus according to the embodiment includes: an adapter that is detachably and electrically connected to an illumination apparatus (lamp)_socket; a power supply unit that is installed in the adapter to supply power; a light emitting device driver that is installed in the adapter and generates driving power from power supplied by the power supply unit; a light emitting device illumination unit including a plurality of light emitting devices that are connected to the adapter and are driven by receiving driving power from the light emitting device driver; a lamp information generator that is installed in the light emitting device illumination unit; and a controller that controls the light emitting device driver according to the lamp information of the lamp information generator.

The present application claims priority under 35 U.S.C. §119(e) of Korean Patent Application No. 10-2009-0001709 (filed on Jan. 9, 2009) which is hereby incorporated by reference in its entirety.

### BACKGROUND

### Description of the Related Art

The present disclosure relates to an illumination apparatus.

At the present time, a fluorescent lamp or an incandescent lamp has been widely used as an illumination apparatus. In particular, the fluorescent lamp has low power consumption and high brightness so that it has been widely used in the office and in the home.

Meanwhile, an illumination apparatus that replaces the fluorescent lamp or the incandescent lamp has been recently developed and, representatively, an illumination apparatus using a light emitting diode (LED) has been introduced. However, in the case of the illumination apparatus using the LED, it is driven with a different voltage than the fluorescent lamp or the incandescent lamp’ As a result, present power supply apparatuses including conventionally installed sockets may not be useable with LED lamps.

### SUMMARY

The present disclosure provides an illumination apparatus with a new structure using an LED or an organic LED (OLED).

The present disclosure provides an illumination apparatus using an LED or an OLED that can be used, without replacing the power supply apparatus installed for a conventional fluorescent or incandescent lamp.

The present disclosure provides an illumination apparatus that can compatibly use various lamps by detachably installing an adapter and a light-emitting device. The adapter of the present illumination apparatus can be firmly coupled to a socket.

The present disclosure provides an illumination apparatus that can adaptively control a light-emitting device according to the type of light-emitting device that is installed.

An illumination apparatus according to the present disclosure includes: an adapter that is detachably and electrically connectable to a lamp socket; a power supply unit in the adapter configured to supply power; a light emitting device driver in the adapter, configured to generate driving power from the power supplied by the power supply unit; a light emitting device illumination unit including a plurality of light emitting devices connected to the adapter and that receive the driving power from the light emitting device driver; a lamp information generator in the light emitting device illumination unit; and a controller that controls the light emitting device driver according to information in the lamp information generator.

A driving method of driving an illumination apparatus according to the present disclosure includes: converting power into driving power in an adapter; obtaining lamp information from a light emitting device illumination unit, the light emitting device illumination unit being detachably and electrically connected to the adapter and including one or more light emitting devices; and controlling the light emitting device illumination unit according to the lamp information using a controller connected to the adapter.

### BRIEF DESCRIPTION OF THE DRAWINGS

FIG. 1 is a diagram for explaining an illumination apparatus according to a first embodiment of the present invention;

FIG. 2 is an isometric view of the illumination apparatus according to the first embodiment of the present invention;

FIG. 3 is a block diagram for explaining a configuration of the illumination apparatus according to the first embodiment of the present invention;

FIG. 4 is a circuit diagram showing a surge voltage absorber in the illumination apparatus according to the first embodiment;

FIG. 5 is a circuit diagram showing an AC-DC converter and a regulator in the illumination apparatus according to the first embodiment;

FIG. 6 is a block diagram showing a light emitting device driver and a light emitting device unit in the illumination apparatus according to the first embodiment;

FIG. 7 is a circuit diagram showing the light emitting device unit and a ramp information generator in the illumination apparatus according to the first embodiment;

FIG. 8 is a illustration showing an illumination apparatus according to a second embodiment;

FIG. 9 is a cross-sectional view of the illumination apparatus according to the second embodiment; and

FIG. 10 is a block diagram for explaining a configuration of the illumination apparatus according to the second embodiment.

### DETAILED DESCRIPTION OF THE EMBODIMENTS

In the drawings, the thickness or size of each layer is exaggerated, omitted or schematically illustrated for the convenience and clarity of explanation. Also, the size of each constituent does not accurately reflect its actual size.

Hereinafter, an illumination apparatus according to various embodiments will be described with reference to the accompanying drawings.

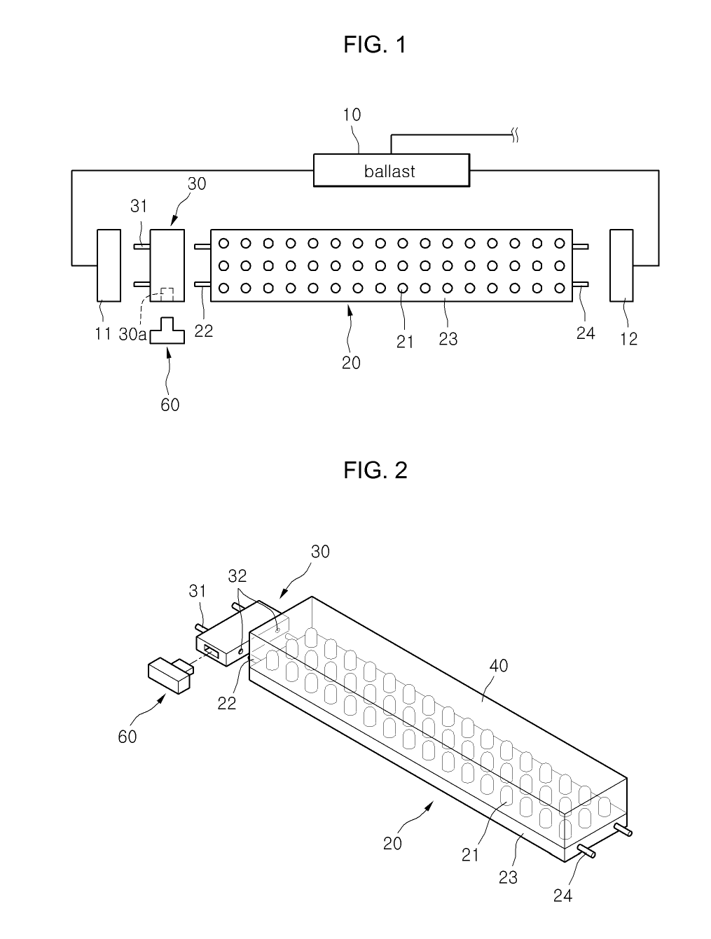

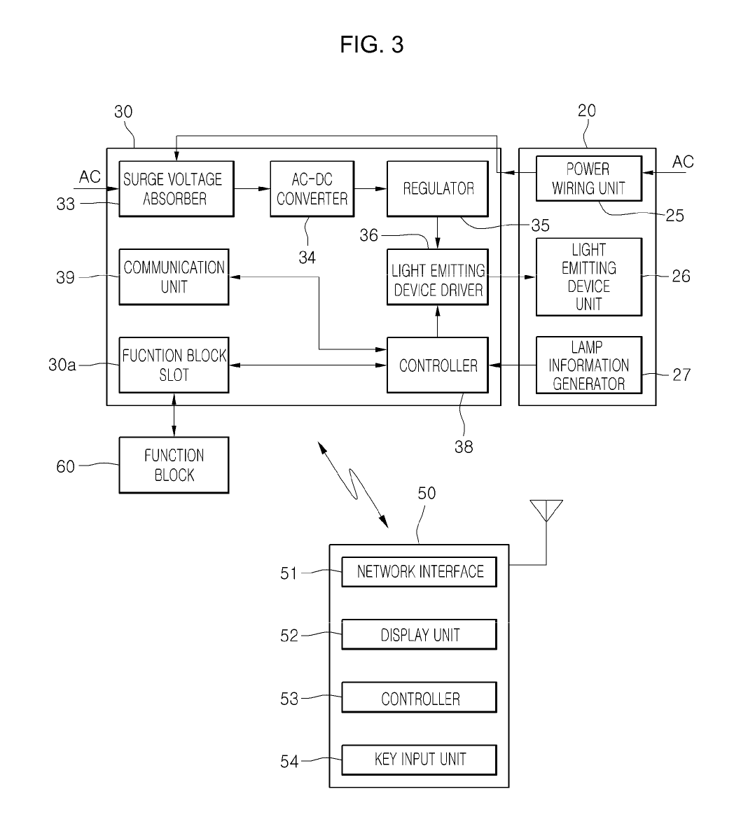

FIG. 1 is a diagram for explaining an illumination apparatus according to a first embodiment and FIG. 2 is an isometric view of the illumination apparatus according to the first embodiment. FIG. 3 is a block diagram for explaining a configuration of the illumination apparatus according to the first embodiment.

Referring first to FIGS. 1 and 2, an illumination apparatus according to the first embodiment includes a lamp shown as a light emitting device illumination unit 20 and an adapter 30 that drives the lamp.

In the light emitting device illumination unit 20, a plurality of light emitting devices 21 are installed on a substrate 23, a connector 22 (which is electrically connected to the adapter 30) is formed on one side of the substrate 23, and a second power supply terminal 24 is formed on an opposite side of the substrate 23 from the connector 22. Further, a cover 40 for protecting the plurality of light emitting device 21 may be further installed on the substrate 23.

One side of the adapter 30 is formed with a connector groove 32 into which the connector 22 is inserted, such that the adapter 30 can be physically and electrically connected to the light emitting device illumination unit 20. A first power supply terminal 31 is formed on another side of the adapter 30 (e.g., an opposite side to the side where the connector groove or socket 32 is formed).

The illumination apparatus according to the first embodiment can be configured to be installed to replace a conventional fluorescent tube lamp. In other words, the illumination apparatus according to the first embodiment may be installed in first and second sockets 11 and 12, in which a conventional fluorescent lamp is installed, by connecting the light emitting device illumination unit 20 and the adapter 30 and plugging the combination of the light emitting device illumination unit 20 and the adapter 30 into sockets 11 and 12. Therefore, the illumination apparatus according to the first embodiment using the light emitting device 21, which consists of an LED or an OLED, can be installed without replacing a power supply apparatus including the first and second sockets 11 and 12, which are configured for a conventional fluorescent tube lamp.

Currently, the power supply apparatus for installing most fluorescent lamps is provided with the first and second sockets 11 and 12 into which a the fluorescent tube lamp is installed. The sockets 11 and 12 provide power and the first and second sockets 11 and 12 are supplied with power through a ballast 10. Therefore, the illumination apparatus according to the first embodiment can be supported on the first and second sockets 11 and 12 and be electrically connected thereto by inserting the first power supply terminal 31 formed in the adapter 30 and a second power supply terminal 24 formed in the light emitting device illumination unit 20 into the first and second sockets 11 and 12, respectively, as shown in FIG. 1.

Power supplied to the first socket 11 is directly supplied to the adapter 30 and power supplied to the second socket 12 is supplied to the adapter 30 through the substrate of the light emitting device illumination unit 20. The adapter 30 receives power supplied from the first socket 11 and the second socket 12 to drive the light emitting device illumination unit 20.

Although the first embodiment describes that the adapter 30 receives power supplied from the first socket 11 and the second socket 12 to drive the light emitting device illumination unit 20, the light emitting device illumination unit 20 can be driven by power supplied from the first socket 11 or the second socket 12 alone.

Meanwhile, since the light emitting device illumination unit 20 and the adapter 30 are detachably installed, when defects occur in the light emitting device illumination unit 20 or the adapter 30, the illumination apparatus according to the first embodiment can replace the light emitting device illumination unit 20 or the adapter 30 where the defects occur, without having to replace both components, which results in low maintenance costs.

In addition, the illumination apparatus according to the first embodiment has an advantage in that it can provide illuminations of a variety of atmospheres (e.g., different colors, intensities, etc.) by replacing the light emitting device illumination unit 20, since the light emitting device illumination unit 20 and the adapter 30 are detachably installed.

Further, the illumination apparatus according to the first embodiment is configured so that the adapter 30 can recognize the type of the light emitting device illumination unit 20 that is installed, and thus adaptively control the light emitting device illumination unit 20.

The illumination apparatus according to a second embodiment can be used to freely select the light emitting device illumination unit 20 having various models manufactured by various manufacturers. This is described in more detail below.

In the light emitting device illumination unit 20, the plurality of light emitting devices 21 are arranged on the substrate 23. The light emitting device 21 may be an LED or an OLED.

The substrate 23 may be formed with a wiring for supplying power to the plurality of light emitting devices 21 from the adapter 30 and a wiring for supplying power supplied from the second socket 12 to the adapter 30. For example, the substrate 23 may be a printed circuit board.

In addition, a reflective coating layer (not shown) may be formed on the surface of the substrate 23, making it possible to increase the efficiency of light emitted from the light emitting devices 21 by coating it with silver (Ag) or aluminum (Al).

The plurality of light emitting devices 21 may include an LED and an OLED that emits red, blue, green, and/or white.

The cover 40 may be made of a transparent plastic material and may be made of plastic having various colors such as red, green, blue, etc., according to a chosen design. In addition, the cover may be made of a translucent material and in this case, it may also provide an illumination with a soft atmosphere.

Further, the adapter 30 is formed with a function block slot 30a into which a function block 60 (which includes one or more of an infrared sensor, an image sensor, and/or a fire sensor) can be inserted.

Referring to FIG. 3, in the illumination apparatus according to the first embodiment, the adapter 30 may include a surge voltage absorber 33, an AC-DC converter 34, a regulator 35, a light emitting device driver 36, a controller 38, a communication unit 39, and a function block slot 30a, and the light emitting device illumination unit 20 may include a power wiring unit 25, a light emitting device unit 26, and a lamp information generator 27.

Describing in more detail, a function block 60 may be inserted into the function block slot 30a of the adapter 30. For example, the function block 60 may include a USB connector and the function block slot 30a may include a slot in which the USB connector can be inserted. An interface and a communication scheme between the function block slot 30a and the function block 60 can be variously selected.

The adapter 30 includes a power supply unit that plays a role of supplying power in the adapter 30. The power supply unit includes the surge voltage absorber 33, the AC-DC converter 34, and the regulator 35.

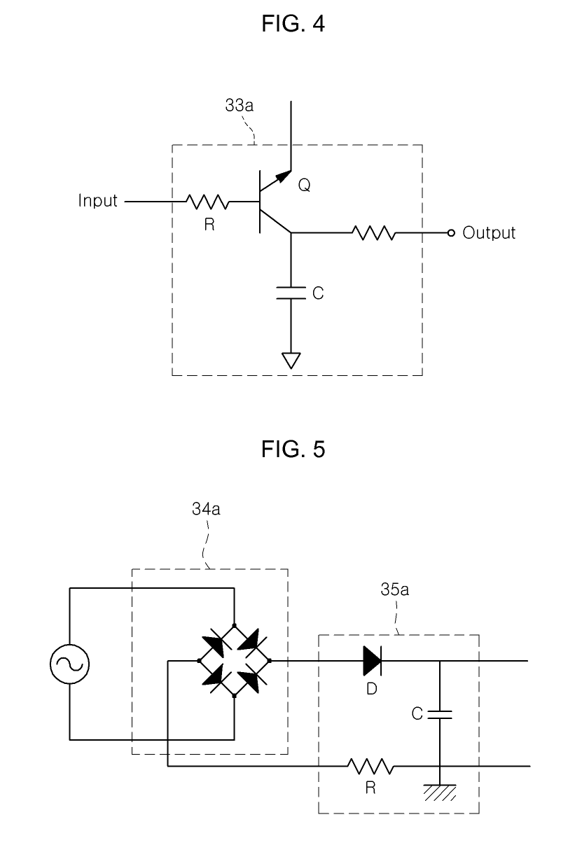

When a surge voltage for lighting a fluorescent lamp is applied from the ballast 10, the surge voltage absorber 33 is installed to absorb the surge voltage. For example, as shown in FIG. 4, the surge voltage absorber may include a surge voltage absorbing circuit 33a.

The surge voltage absorber 33 receives AC power that is provided from the first socket 11 and an AC power that is supplied from the second socket 12 through the power wiring unit 25 of the light emitting device illumination unit 20.

The AC-DC converter 34 converts the AC power supplied through the first and second sockets 11 and 12 into the DC power and the regulator 35 allows the DC power output from the AC-DC converter 34 to be output at a predetermined DC voltage (e.g., a constant DC voltage). For example, as shown in FIG. 5, the AC-DC converter 34 and the regulator 35 may include a bridge rectifying circuit 34a and a smoothing circuit 35a.

As described above, the power supply unit of the adapter 30 receives the AC power from the first socket 11 and the second socket 12 and converts the AC power into the DC power to supply power.

The light emitting device driver 36 outputs the DC voltage supplied from the regulator 35 as a driving power that is suitable to drive the plurality of light emitting device 21 (e.g., the driving pulse).

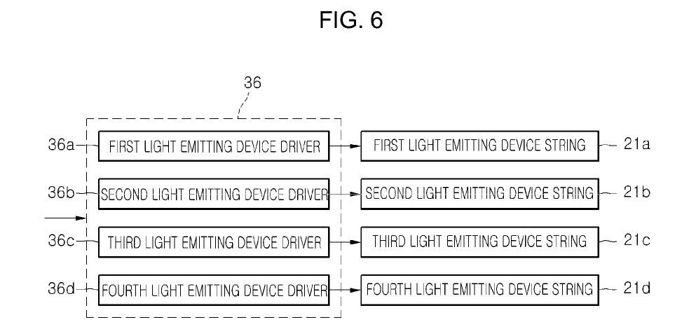

For example, as shown in FIG. 6, the light emitting device driver 36 may include a first light emitting device driver 36a, a second light emitting device driver 36b, a third light emitting device driver 36c, and a fourth light emitting device driver 36d, and the first light emitting device driver 36a drives a first light emitting device string 21a, the second light emitting device driver 36b drives a second light emitting device string 21b, the third light emitting device driver 36c drives a third light emitting device string 21c, and the fourth light emitting device driver 36d drives a fourth light emitting device string 21d. The first light emitting device string 21a, the second light emitting device string 21b, the third light emitting device string 21c, and the fourth light emitting device string 21d are formed in the light emitting device unit 26 of the light emitting device illumination unit 20.

For example, the first light emitting device string 21a may be formed by connecting a plurality of LEDs or OLEDs that emit red light in series, the second light emitting device string 21b may be formed by connecting a plurality of LEDs or OLEDs that emit green light in series, the third light emitting device string 21c may be formed by connecting a plurality of LEDs or OLEDs that emit blue light in series, and the fourth light emitting device string 21d may be formed by connecting a plurality of LEDs or OLEDs that emit white light in series.

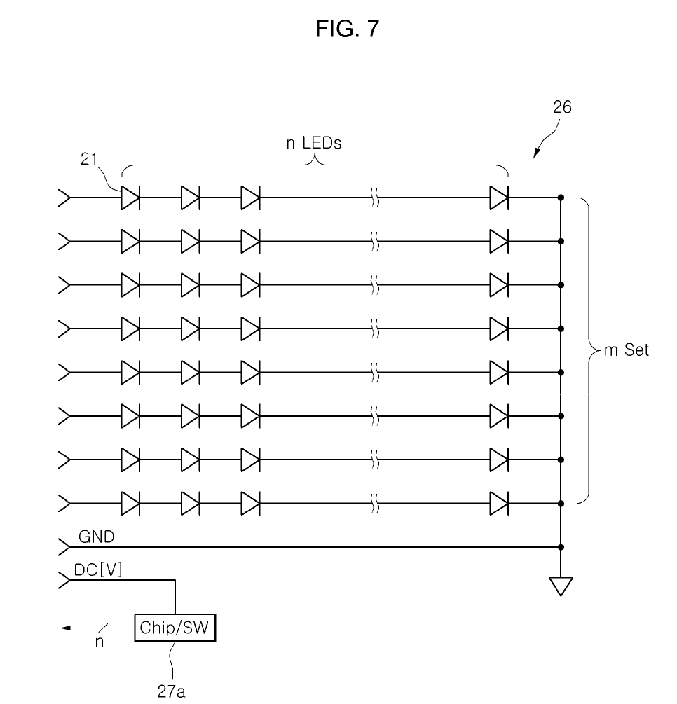

For example, as shown in FIG. 7, the light emitting device unit 26 may be connected to the plurality of light emitting devices 21 and the plurality of light emitting devices 21 may include the plurality of light emitting device strings as shown in FIG. 6. For example, FIG. 7 shows m Set of LED or OLED strings to which n LEDs are connected in series.

The light emitting device driver 36 controls the first light emitting device driver 36a, the second light emitting device driver 36b, the third light emitting device driver 36c, and the fourth light emitting device driver 36d to control the length, interval, etc., of the driving pulse of the first light emitting device string 21a, the second light emitting device string 21b, the third light emitting device string 21c, and the fourth light emitting device string 21d, allowing various colors of light to be emitted.

For example, when the driving pulse is applied to only the first light emitting device string 21a by driving only the first light emitting device driver 36a, the light emitting device illumination unit 20 emits red light.

For further example, when the driving pulse is applied to only the fourth light emitting device string 21d by driving only the fourth light emitting device driver 36d, the light emitting device illumination unit 20 light emits white light. Moreover, all of the light emitting device drivers 36a-36d are driven to apply driving pulses to all of the first light emitting device string 21a, the second light emitting device string 21b, the third light emitting device string 21c, and the fourth light emitting device string 21d, brighter (more) white light is emitted from the light emitting device illumination unit 20 light.

The controller 38 controls the first light emitting device driver 36a, the second light emitting device driver 36b, the third light emitting device driver 36c, and the fourth light emitting device driver 36d to drive the first light emitting device string 21a, the second light emitting device string 21b, the third light emitting device string 21c, and the fourth light emitting device string 21d.

For example, the controller 38 provides different driving pulse information to the first light emitting device driver 36a, the second light emitting device driver 36b, the third light emitting device driver 36c, and the fourth light emitting device driver 36d, thereby making it possible to control the color, brightness, saturation, flickering, etc., of light that is light emitted from the plurality of light emitting devices 21.

The light emitting device illumination unit 20 is also formed with the lamp information generator 27.

The lamp information generator 27 provides the lamp information on the light emitting device illumination unit 20 to the controller 38 of the adapter 30. The lamp information generator 27 may provide lamp information to the controller 39 using an electrical/mechanical method. For example, FIG. 7 shows a chip 27a in which software (SW) including the lamp information on the light emitting device illumination unit 20 is provided.

The lamp information on the light emitting device illumination unit 20 may include, for example, at least one of the size information of the substrate 23, the type and number of the plurality of light emitting devices 21 installed on the substrate 23, the brightness and color information of the light that is emitted from the light emitting device illumination unit 20, and the power information that includes voltage and current suitable to drive the light emitting device illumination unit 20.

When the lamp information generator 27 is provided in a chip 27a as shown in FIG. 7, the lamp information generator 27 receives DC voltage (DC) from the adapter 30 and supplies the lamp information to the controller 38 of the adapter 30.

The controller 38 receives the lamp information, thereby making it possible to adaptively drive the light emitting device illumination unit 20 according to the lamp information. For example, the controller 38 may supply voltage and current suitable for the light emitting device illumination unit 20 according to the power information of the lamp information.

For example, the controller 38 may supply the driving signal suitable to emit light of the desired brightness and color from the light emitting device illumination unit 20 according to the brightness and color information of light that is emitted from the light emitting device illumination unit 20.

The communication unit 39 performs communication with a remote controller 50 and the controller 38 can be remotely controlled by the remote controller 50. The communication unit 39 and the remote controller 50 can perform communication according to a wireless communication scheme, for example, the Zigbee standard.

The remote controller 50 includes a network interface 51 that transmits data to the communication unit 39, a key input unit 54 that inputs an operational command of a user, a display unit 52 that shows an operational state of the user, and a controller 53 that controls the network interface 51 and the display unit 52 according to the signal of the key input unit 54.

Therefore, the user transmits the control command to the communication unit 39 using the remote controller 50, such that the communication unit 39 transmits a control command of the user to the controller 38, thereby making it possible to control the light emitting device illumination unit 20.

For example, the user can perform a control command to emit light of a specific color from the light emitting device illumination unit 20 using the remote controller 50, the controller 38 can control the first light emitting device driver 36a, the second light emitting device driver 36b, the third light emitting device driver 36c, and the fourth light emitting device driver 36d to be selectively driven according to the signal input from the communication unit 39.

In addition, the user can turn-on or turn-off the light emitting device illumination unit 20 using the remote controller 50 after a predetermined time elapses. In other words, the controller 38 can control the light emitting device driver 36 according to the predetermined time by inputting a timer function.

The function block 60 is detachably connected to the function block slot 30a of the adapter 30, making it possible to be connected to the controller 38. The function block 60 may include one or more of an infrared sensor, an image sensor, and/or a fire sensor.

For example, the function block 60 can be installed with an infrared sensor to perform a security function and when the motion of the user is sensed through the infrared sensing, the function block 60 transmits the sensed signal to the controller 38, and the controller 38 can transmit the sensed information to the remote controller 50 through the communication unit 39.

In addition, the function block can be installed with an image sensor to perform a security function and when the image obtained through the image sensor is transmitted to the controller 38, and the controller 38 can transmit the image to the remote controller 50 through the communication unit 39.

In addition, the function block can be installed with a fire sensor to perform a fire sensing function and when fire is sensed through the fire sensor, the function block 60 transmits the sensed signal to the controller 38, and the controller 38 can transmit the sensed information to the remote controller 50 through the communication unit 39. A speaker (not shown) is installed in the adapter 30, such that the fire alarm can be outputted from the speaker by the controller 38 after it obtains the fire sensing signal.

Moreover, the function block 60 may also include a CPU for control operations and for transmitting and executing instructions, a wireless module for communication with external devices, and ROM and RAM for programming and memory.

The user can perform various controls that include the turn on/off of the operation of the function block 60 through the remote controller 50.

As described above, the illumination apparatus according to the first embodiment can be also used in the power supply apparatus for the existing fluorescent lamp that supplies the AC power by the adapter 30 including the surge voltage absorber 33, the AC-DC converter 34, the regulator 35, and the light emitting device driver 36.

In other words, as shown in FIG. 1, the power supply apparatus for the fluorescent lamp includes the ballast 10 that converts commercial power into a high frequency current of 20 to 50 kHz and the first and second sockets 11 and 12 that are connected to the ballast 10. Since only the high frequency AC current is supplied through the first and second sockets 11 and 12, the light emitting device illumination unit 20 cannot be directly installed on the existing power supply apparatus. However, the illumination apparatus according to the embodiment installs the adapter 30, making it possible to use the light emitting device illumination unit 20, while using the conventional power supply apparatus.

Moreover, the illumination apparatus according to the first embodiment can obtain the lamp information of the light emitting device illumination unit 20 in the adapter 30, making it possible to adaptively control the light emitting device illumination unit 20 according to the characteristics of the light emitting device illumination unit 20 that is connected to the adapter 30.

In addition, the illumination apparatus according to the embodiment can be remotely controlled by the adapter 30 that includes the communication unit 39 performing communication with the remote controller 50.

In addition, the illumination apparatus according to the first embodiment includes the function block slot 30a and the function block 60 that is detachable to the function block slot 30a, thereby making it possible to perform the security function and the fire sensing function, etc. together with the illumination function.

In the present disclosure, although any one of the infrared sensor, the image sensor, and the fire sensor may be included in the function block 60, the communication unit 39 may be formed in the function block 60, such that it can be detachably installed in the adapter 30.

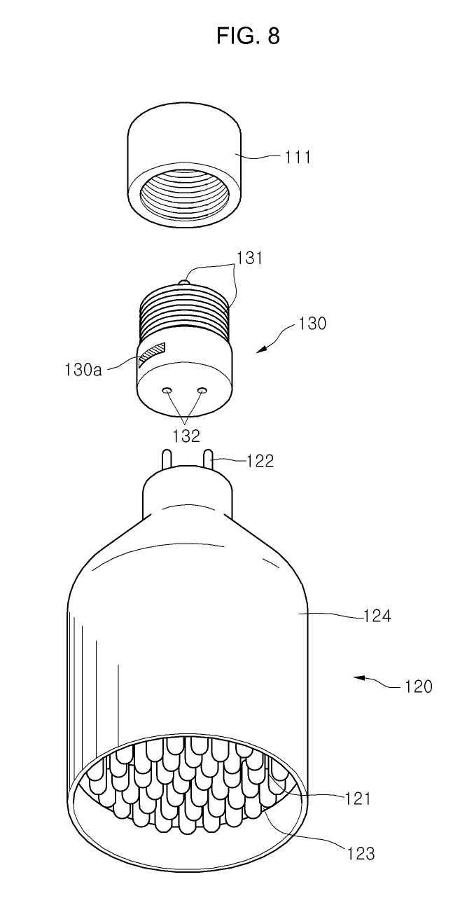

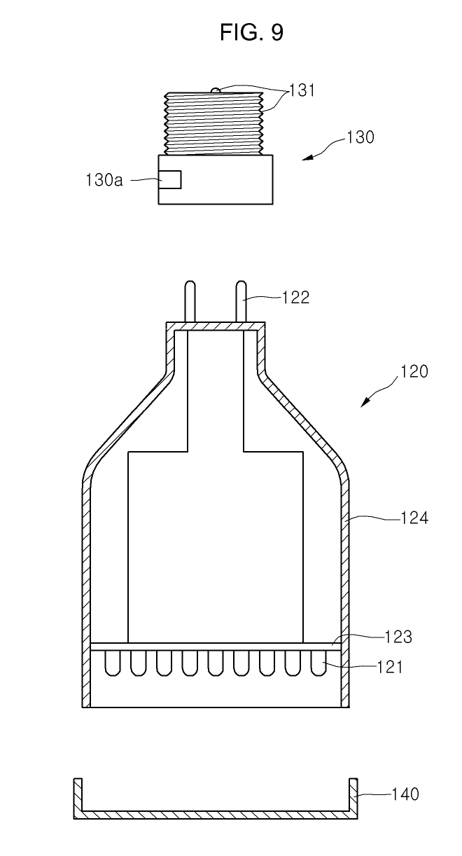

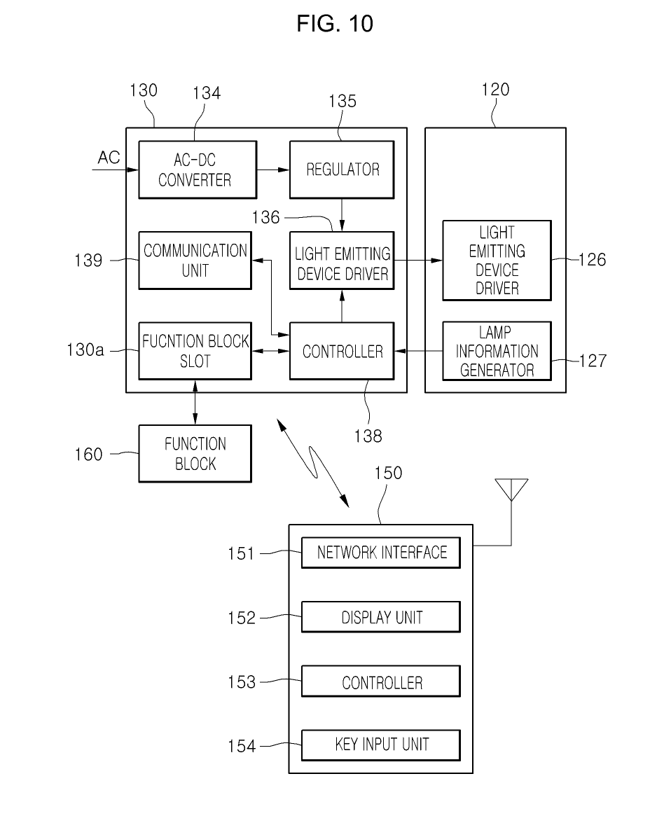

FIG. 8 is an illustration for explaining an illumination apparatus according to a second embodiment and FIG. 9 is a cross-sectional view of the illumination apparatus according to the second embodiment. FIG. 10 is a block diagram for explaining a configuration of the illumination apparatus according to the second embodiment.

The illumination apparatus according to the second embodiment shows an exemplary embodiment that can be installed in an incandescent lamp socket or a halogen lamp socket and in describing the illumination apparatus according to the second embodiment, description of portions of the second embodiment that are identical to the first embodiment will be omitted.

Referring to FIGS. 8 and 9, the illumination apparatus according to the second embodiment includes an adapter 130 that can be connected to a socket 111 capable of receiving an incandescent lamp or a halogen lamp, etc., and a light emitting device illumination unit 120 that is detachably connected to the adapter 130.

The adapter 130 is formed with spiral protrusions to be connected to the socket 111 and includes a power supply terminal 131 that can be electrically connected to the socket 111 and a connector groove 132 that can be electrically connected to the light emitting device illumination unit 120.

The light emitting device illumination unit 120 includes a connector 122 that is inserted into and electrically connects with the connector groove 132, a housing 124 on which the connector 122 is installed, a substrate 123 that is connected to the housing 124, and the plurality of light emitting devices 121 that are installed on the substrate 123. In addition, in order to protect the plurality of light emitting devices 121, it may further include a cover 140 that is connected to the housing 124.

The substrate 123 may be a printed circuit board (PCB) on which a circuit pattern for providing power to the plurality of light emitting devices 121 is formed. In addition, the substrate 123 may be a substrate on which a wiring for providing power to the plurality of light emitting devices 121 is installed. The substrate 123 is electrically connected the connector 122.

In addition, a reflective coating layer (not shown) may be formed on the surface of the substrate 123, making it possible to increase the efficiency of light emitted from the plurality of light emitting devices 121 by coating it with silver (Ag) or aluminum (Al).

In the embodiment, the substrate 123 is formed in a plate-type shape and is installed inside the housing 124. Therefore, when the cover 140 is connected to the housing 124, the substrate 123 and the plurality of light emitting devices 121, which is installed on the substrate 123, are surrounded by the housing 124 and the cover 140.

The plurality of light emitting devices 121 may be formed as a plurality of LEDs or OLEDs. For example, the plurality of light emitting devices 121 may include LEDs and/or an OLEDs that emit red, blue, and/or white.

The cover 140 may be made of a transparent plastic material having various colors such as red, green, blue, etc., according to a chosen design. In addition, the cover may be made of a translucent material, and in this case, it may also provide an soft light illumination.

The illumination apparatus according to the second embodiment may be installed in the socket 111 which is configured for a conventional incandescent lamp or halogen lamp, etc. For example, the illumination apparatus can be installed by connecting the light emitting device illumination unit 120 and the adapter 130, and screwing the spiral protrusions of the adapter 130 into the socket 111 to electrically connect the power supply terminal 131 with the socket 111.

In addition, in the illumination apparatus according to the second embodiment, the adapter 130 converts the AC power from the socket 111, which is conventionally applied to the incandescent lamp or halogen lamps, into the DC power, thereby making it possible to drive the plurality of light emitting devices 121.

Therefore, the embodiment can use the illumination apparatus using the LED or the OLED without replacing the power supply apparatus including the socket 111 in which conventional incandescent and halogen lamps are typically installed.

In particular, since the light emitting device illumination unit 120 and the adapter 130 are detachably connected to each other, when defects are generated on the light emitting device illumination unit 120 or the adapter 130, only the light emitting device illumination unit 120 or the adapter 130 where the defects occur needs to be replaced, resulting in low maintenance costs.

In addition, the illumination apparatus according to the second embodiment has an advantage that it can provide illumination of a variety of colors, intensities, and atmospheres by replacing the light emitting device illumination unit 120, since the light emitting device illumination unit 120 and the adapter 130 are detachable and replaceable.

Further, the illumination apparatus according to the second embodiment is configured so that the adapter 130 can recognize the type of light emitted by the light emitting device illumination unit 120, and thus can adaptively control the light emitting device illumination unit 120. Therefore, the illumination apparatus according to the second embodiment allows the user to freely select the light emitting device illumination unit 120 having various models manufactured by various manufacturers.

Referring to FIG. 10, the adapter 130 may include an AC-DC converter 134, a regulator 135, a light emitting device driver 136, a controller 138, a communication unit 139, and a function block slot 130a and the light emitting device illumination unit 120 may include the light emitting device unit 126 and the lamp information generator 127.

Describing in more detail, the function block slot 130a of the adapter 130 may be inserted with a function block 160. For example, the function block 160 may include a USB connector and the function block slot 130a may include a slot in which the USB connector can be inserted. An interface and a communication scheme between the function block slot 130a and the function block 160 can be variously selected.

A power supply unit which supplies power in the adapter 130 includes the AC-DC converter 134 and the regulator 135.

The AC-DC converter 134 converts the AC power supplied through the socket 111 into DC power and the regulator 135 can output the DC power from the AC-DC converter 134 at a predetermined DC voltage. For example, as shown in FIG. 5, the AC-DC converter 134 and the regulator 135 may be formed in the form of the bridge rectifying circuit 34a and the smoothing circuit 35a.

The light emitting device driver 136 outputs the DC voltage supplied from the regulator 135 as the driving power suitable to drive the plurality of light emitting devices 121, (e.g., the driving pulse).

As shown in FIG. 6, the light emitting device driver 136 may include a first light emitting device driver 36a, a second light emitting device driver 36b, a third light emitting device driver 36c, and a fourth light emitting device driver 36d, and the first light emitting device driver drives a first light emitting string 21a, the second light emitting device driver drives a second light emitting device driver 21b, the third light emitting device driver droves a third light emitting device string 21c, and the fourth light emitting device driver drives, a fourth light emitting device string 21d. Each of the light emitting devices strings 21a-21d are installed on the light emitting device illumination unit 120.

The operation of the light emitting device driver 136 is the same as the light emitting device driver 36 according to the first embodiment and therefore, the repeated description thereof will be omitted.

The controller 138 controls the first light emitting device driver, the second light emitting device driver, the third light emitting device driver, and the fourth light emitting device driver and causes them to drive the first light emitting device string, the second light emitting device string, the third light emitting device string, and the fourth light emitting device string.

For example, the controller 138 provides different driving pulse information to each of the first light emitting device driver, the second light emitting device driver, the third light emitting device driver, and the fourth light emitting device driver, thereby making it possible to control the color, brightness, saturation, flickering, etc., of light that is emitted from the plurality of light emitting devices 121.

The light emitting device illumination unit 120 is formed with the lamp information generator 127. The lamp information generator 127 provides the lamp information regarding the light emitting device illumination unit 120 to the controller 138 of the adapter 130. The lamp information generator 127 can provide the lamp information to the controller 138 by an electrical/mechanical method and, as shown in FIG. 7, and can be formed in a chip 27a.

The lamp information on the light emitting device illumination unit 120 may include, for example, at least one of the size of the substrate 123, the type and number of the plurality of light emitting devices 121 installed on the substrate 123, the brightness and color information of light that is emitted from the light emitting device illumination unit 120, and power information that includes voltage and current suitable to drive the light emitting device illumination unit 120.

The lamp information generator 127 receives the DC voltage from the adapter 130 and supplies it to the controller 138 of the adapter 130.

The controller 138 receives the lamp information, thereby making it possible to adaptively drive the light emitting device illumination unit 120 according to the lamp information.

For example, the controller 138 may supply voltage and current suitable for the light emitting device illumination unit 120 according to the power information provided by the lamp information generator 127.

As a further example, the controller 138 may supply the driving signal suitable to emit the desired brightness and color in the light emitting device illumination unit 120 according to the brightness and color information of light that is emitted from the light emitting device illumination unit 120.

The communication unit 139 performs communication with a remote controller 150 and the controller 138 can be remotely controlled by the remote controller 150. The communication unit 139 and the remote controller 150 can perform communication according to a wireless communication scheme, for example, a Zigbee standard.

The remote controller 150 includes a network interface 151 that transmits data to the communication unit 139, a key input unit 154 that inputs an operational command of a user, a display unit 152 that shows an operational state of the user, and a controller 153 that controls the network interface 151 and the display unit 152 according to the signal of the key input unit 154.

Therefore, the user transmits the control command to the communication unit 139 using the remote controller 150, such that the communication unit 130 transmits a control command of the user to the controller 138, thereby making it possible to control the light emitting device illumination unit 120.

The function block 160 is detachably connected to the function block slot 130a of the adapter 130 to connect to the controller 138. The function block 160 may be installed with one or more of an infrared sensor, an image sensor, and/or a fire sensor, as described above with regard to the first embodiment.

As described above, the illumination apparatus according to the second embodiment can be also used with a conventional power supply apparatus for the existing fluorescent lamp or the halogen lamp that can supply AC power to the adapter 130 including the AC-DC converter 134, the regulator 135, and the light emitting device driver 136.

Moreover, the illumination apparatus according to the second embodiment can obtain the lamp information of the light emitting device illumination unit 120 in the adapter 130, making it possible to adaptively control the light emitting device illumination unit 120 according to the characteristics of the light emitting device illumination unit 120 that is connected to the adapter 130.

In addition, the illumination apparatus according to the embodiment can be remotely controlled by with the remote controller 150 communicates with the communication unit 139 in the adapter 130.

In addition, the illumination apparatus according to the second embodiment includes the function block slot 130a and the function block 160 that is detachable to the function block slot 130a, thereby making it possible to perform a security function and a fire sensing function, etc. together with the illumination function.

The present disclosure can provide an illumination apparatus comprising the LED or the OLED light sources.

The present disclosure can provide an illumination apparatus using the LED or the OLED that can be used, without replacing a conventional power supply apparatus installed for use with conventional fluorescent lamp, incandescent lamp, or a halogen lamp, etc.

The present disclosure can provide an illumination apparatus that can compatibly use various lamps by detachably installing the adapter and the lamp.

The present disclosure can provide an illumination apparatus that can adaptively control the lamp according to the type of the lamp that is installed.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An illumination apparatus, comprising:
an adapter that is detachably and electrically connectable to a lamp socket;
a power supply unit in the adapter configured to supply power;
a light emitting device driver in the adapter, configured to generate driving power from the power from the power supply unit;
a light emitting device illumination unit including a plurality of light emitting devices connected to the adapter and that receive the driving power from the light emitting device driver;
a lamp information generator in the light emitting device illumination unit; and
a controller that controls the light emitting device driver according to information in the lamp information generator.

2. The illumination apparatus according to claim 1, wherein the adapter comprises a connector groove, and the light emitting device illumination unit comprises a connector complementary to the connector groove and connectable thereto.

3. The illumination apparatus according to claim 1, wherein the plurality of light emitting device comprise LEDs or OLEDs.

4. The illumination apparatus according to claim 1, wherein the information in the lamp information generator includes size information of the light emitting device illumination unit.

5. The illumination apparatus according to claim 1, wherein the information in the lamp information generator includes information on a type and a number of the plurality of light emitting devices in the light emitting device illumination unit.

6. The illumination apparatus according to claim 1, wherein the information in the lamp information generator includes brightness and color of light that is emitted from the light emitting device illumination unit.

7. The illumination apparatus according to claim 1, wherein the information in the lamp information generator includes a voltage and a current suitable for the light emitting device illumination unit or components thereof.

8. The illumination apparatus according to claim 1, wherein the lamp information generator supplies the information to the controller electrically and mechanically.

9. The illumination apparatus according to claim 1, wherein the lamp information generator is on a chip, and the information is stored in a memory on the chip.

10. The illumination apparatus according to claim 1, wherein the lamp socket is a fluorescent lamp socket.

11. The illumination apparatus according to claim 1, wherein the lamp socket is an incandescent lamp socket.

12. The illumination apparatus according to claim 1, wherein the lamp socket is a halogen lamp socket.

13. The illumination apparatus according to claim 1, wherein the power supply unit comprises an AC-DC converter that receives AC power from a the lamp socket and converts it to DC power.

14. The illumination apparatus according to claim 1, wherein the adapter comprises a function block slot for receiving a function block.

15. The illumination apparatus according to claim 14, wherein the function block comprises one or more of an infrared sensor, an image sensor, a smoke sensor, a motion sensor, and a thermal sensor.

16. A method of driving an illumination apparatus, comprising:
converting power into driving power in an adapter;
obtaining lamp information from a light emitting device illumination unit, the light emitting device illumination unit being detachably and electrically connected to the adapter and including one or more light emitting devices; and
controlling the light emitting device illumination unit according to the lamp information using a controller connected to the adapter.

17. The method according to claim 16, wherein the lamp information comprises information on a type or number of the plurality of light emitting devices in the light emitting device illumination unit, a brightness or color of light emitted from the light emitting device illumination unit, a voltage or a current suitable for the light emitting device illumination unit or component(s) thereof, and a size of the light emitting device illumination unit.

18. The method according to claim 16, wherein the controller obtains the lamp information by an electrical or mechanical method.

19. The method according to claim 16, wherein the light emitting device illumination unit includes a plurality of light emitting devices, the adapter comprises a plurality of light emitting device drivers that are connected to a controller, and the controller applies different driving power to each of the plurality of light emitting device drivers.

20. The method according to claim 19, wherein each of the plurality of light emitting device drivers are electrically connected to a subset of the plurality of light emitting devices.
